(19) United States
(12) Patent Application Publication
(10) Pub. No.: US 2011/0135265 A1
(43) Pub. Date: Jun. 9, 2011

(54) METHOD OF FORMING WAVEGUIDE FACET AND PHOTONICS DEVICE USING THE METHOD

(75) Inventors: Sahnggi PARK, Daejeon (KR); Kap-Joong Kim, Daejeon (KR); Gyungock Kim, Seoul (KR)

(73) Assignee: Electronics and Telecommunications Research Institute, Daejeon (KR)

(21) Appl. No.: 12/842,287

(22) Filed: Jul. 23, 2010

(30) Foreign Application Priority Data
Dec. 8, 2009 (KR) 10-2009-0121079

(51) Int. Cl. G02B 6/10; C23F 1/00

(52) U.S. Cl. 385/129; 216/24; 216/2

(57) ABSTRACT

Provided are a method of forming a waveguide facet and a photonics device using the method. The method includes forming at least one optical device die including waveguides on a substrate, forming at least one trench in a lower surface of the substrate, and cleaving the substrate to form facets of the waveguides over the trench. The trench is formed along a direction crossing the waveguides under the waveguides.

### CROSS-REFERENCE TO RELATED APPLICATIONS

This U.S. non-provisional patent application claims priority under 35 U.S.C. §119 of Korean Patent Application No. 10-2009-0121079, filed on Dec. 8, 2009, the entire contents of which are hereby incorporated by reference.

### BACKGROUND OF THE INVENTION

The present invention disclosed herein relates to a photonics technology, and more particularly, to a method of forming a waveguide facet and a photonics device using the method.

Today, communications between boards in computers, and communications between chips in boards or communications between electronic devices in semiconductor chips are typically performed using electric methods. However, such communications using electric methods may cause technical limitations such as low speed, high resistance, high temperature, and parasitic capacitance, as well known in the art. Since such technical limitations can be suppressed using optical communication technologies, research for applying the optical communication technologies to communications between boards, and communications between chips or electronic devices is being and will be actively carried out.

To embody optical communication technologies in typical silicon semiconductor integrated circuits, silicon photonic technologies of forming optical devices and optical waveguides with silicon are required. In this case, optical connection technologies of constituting silicon optical waveguides to allow input/output of external optical signals are specially required to commercialize silicon photonic technologies. Typically, such optical connection technologies may be embodied by connecting optical waveguide facets to optical fibers in butting manner. At this point, the optical waveguide facets are required to be clearly formed so as to inhibit optical loss due to scattering or reflection. However, when silicon wafers are used, the yield is significantly reduced, and fabricating costs are increased.

In more detail, when optical waveguide facets are obtained from a compound semiconductor substrate, the optical waveguide facets may be formed by performing a backside polishing step to reduce the thickness of the substrate, and then, by cleaving the substrate along crystal surfaces of the substrate. However, since silicon wafers have high hardness, it is difficult to perform a backside polishing step and a cleaving step on silicon wafers. For example, a backside polishing step may be performed with sand paper, but a number of minute holes or crystalline defects may be randomly formed in the backside of a substrate during the backside polishing step. As such, due to randomly formed minute holes, a silicon substrate may be cloven out of desired crystal surfaces. This may cause breakage of an optical device, not an optical waveguide, thus reducing the yield. According to an experiment performed by the inventors, such a technical limitation became more serious when a silicon-on-insulator (SOI) wafer was used. In addition, essentially, the success rate of a cleaving process did not depend on whether a crystal plane of a wafer was (100) or (110).

### SUMMARY OF THE INVENTION

The present invention provides a method of forming a clear waveguide facet.

The present invention also provides a method of forming a waveguide facet, which can improve the yield.

Embodiments of the present invention provide methods of forming a waveguide facet, the methods including: forming at least one optical device die on a substrate, the optical device die including waveguides; forming at least one trench in a lower surface of the substrate; and cleaving the substrate to form facets of the waveguides over the trench, wherein the trench is formed along a direction crossing the waveguides under the waveguides.

In some embodiments, the substrate may be formed of material having a single crystal structure. The trench may define a fragile region having mechanical fragileness in the substrate, and the cleaving of the substrate may use the mechanical fragileness of the fragile region to confine positions where the facets are formed within the upper side of the trench. The cleaving of the substrate may include using a mechanical method to apply mechanical force to the fragile region.

In other embodiments, the substrate may include a single crystal silicon wafer. The substrate may further include a lower layer having low refractivity than that of the waveguide, and formed under the waveguides. The waveguides may be formed of silicon.

In still other embodiments, the forming of the optical device die may include processing a silicon-on-insulator (SOI) wafer including a single crystal silicon wafer, an oxide layer, and a silicon layer, the single crystal silicon wafer may be used as the substrate, and the silicon layer of the processed silicon-on-insulator wafer may be used as the waveguides.

In even other embodiments, the optical device die may include a plurality of optical device dies spatially separated from each other by a boundary region, and arrayed in two dimensions on the substrate, and the trench may be horizontally spaced apart from the boundary region between the optical device dies and disposed in the lower surface of the substrate. The optical device dies may be formed using a pattern transfer process including a plurality of exposure operations, and the boundary region may be formed in regions on which different ones of the exposure operations are performed.

In yet other embodiments, the forming of the trench may include forming a plurality of trenches in the lower surface of the substrate, and one or two of the trenches may be formed below each of the optical device dies. The optical device dies may include a reference die spaced a predetermined distance from a side wall of the substrate, and the forming of at least one trench may include forming a reference trench under the reference die; and repeatedly forming the trench at a position that is spaced a pitch of the optical device die from the reference trench or the trench as a reference line.

In further embodiments, the methods may further include, before the forming of the trench, forming a reference mark in a predetermined region of the substrate, wherein the trench is formed using the reference mark as a reference line. The reference mark may include a side wall of the substrate formed by cutting an edge of the substrate along a direction parallel to the trench.

In other embodiments of the present invention, photonics devices include an optical device including a connection waveguide to optically connect to an external optical device, wherein the connection waveguide has a facet disposed at an edge of the optical device, and the facet of the connection waveguide is formed using one of the aforementioned methods.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a flowchart illustrating a method of forming a waveguide facet according to an embodiment of the present invention;

FIGS. 2 through 7 are schematic views illustrating the method of FIG. 1;

FIGS. 8 through 12 are schematic views illustrating the method of FIG. 1 in more detail;

FIGS. 13 through 16 are cross-sectional views illustrating a method of forming a waveguide facet according to an embodiment of the present invention;

FIG. 17 is a flowchart illustrating a method of forming a waveguide facet according to another embodiment of the present invention;

FIGS. 18 and 19 are perspective views illustrating the method of FIG. 17;

FIGS. 20 and 21 are flowcharts illustrating methods of forming a waveguide facet according to other embodiments of the present invention;

FIGS. 22 through 24 are perspective views illustrating a method of forming a waveguide facet according to an embodiment of the present invention; and

FIG. 25 is a schematic view illustrating a photonics device according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, it will be understood that when an element such as a layer, film, region, or substrate is referred to as being “on” another element, it can be directly on the other element or intervening elements may also be present. In the figures, the dimensions of layers and regions are exaggerated for clarity of illustration. Also, though terms like a first, a second, and a third are used to describe various regions and layers in various embodiments of the present invention, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof.

Hereinafter, it will be described about exemplary embodiments of the present invention in conjunction with the accompanying drawings.

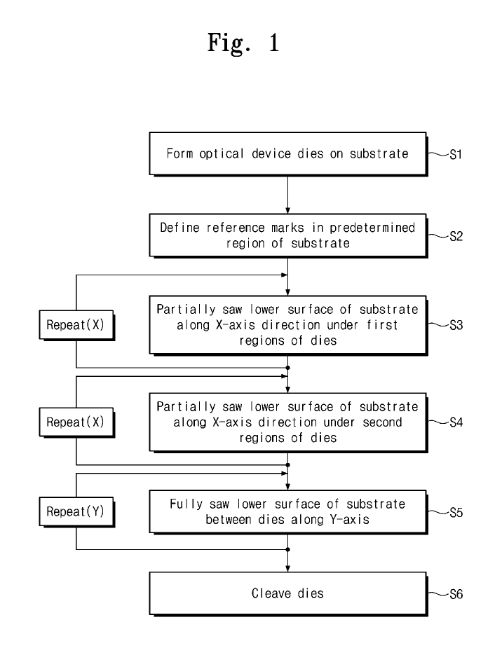

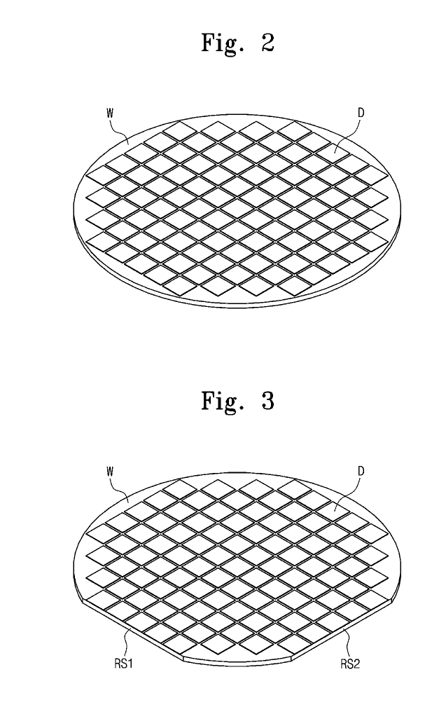

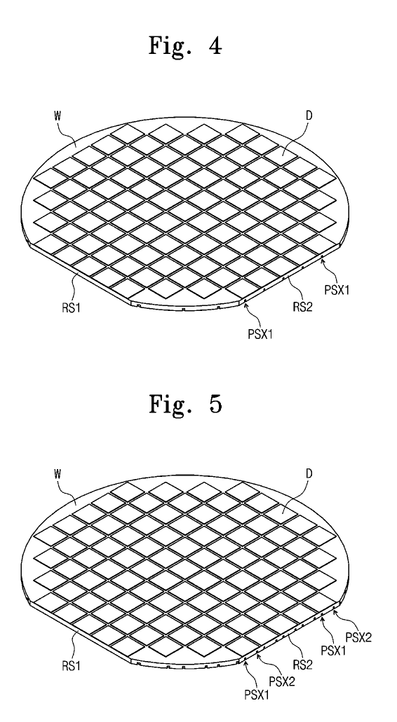

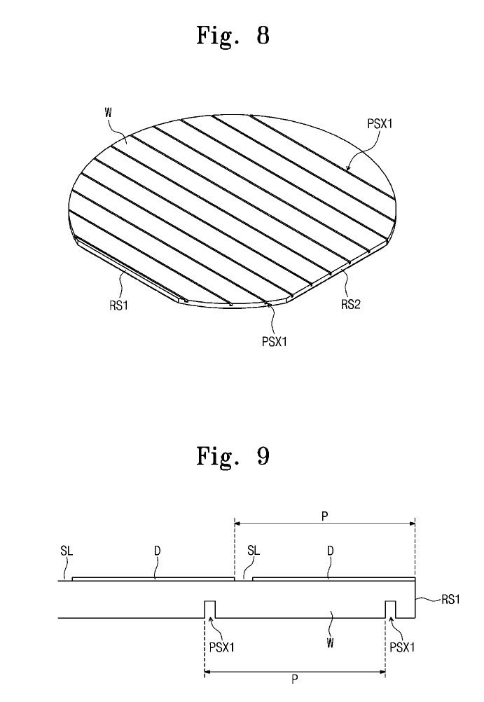

FIG. 1 is a flowchart illustrating a method of forming a waveguide facet according to an embodiment of the present invention. FIGS. 2 through 7 are schematic views illustrating the method of FIG. 1. FIGS. 8 through 12 are schematic views illustrating the method of FIG. 1 in more detail. In detail, FIGS. 8, 10 and 12 are perspective views illustrating the lower surface of a substrate in operations described with reference to FIGS. 4 through 6, and FIGS. 9 and 11 are cross-sectional views taken from FIGS. 4 and 5 in the operations described with reference to FIGS. 4 through 6.

Referring to FIGS. 1 and 2, in operation 51, optical device dies D are formed on a substrate W. The optical device dies D (or dies) may be arrayed in two dimensions on the substrate W. The term “optical device die” means a region having at least both (1) substantial identity in shape and (2) independence in function, which will now be described.

(1) Substantial Identity in Shape

A part or whole of the optical device dies D may be substantially identical. For example, one of the optical device dies D and at least one of the optical device dies D may have translational, rotational or mirror symmetry in shape.

Meanwhile, the number of types of the optical device dies D having identity in shape may be two or greater.

(2) Independence in Function

Each of the optical device dies D may be an independent region including optical elements configured to perform a predetermined function. That is, the optical device dies D may be configured to perform a substantially identical function, but operate independently from each other, and be not organically connected to each other.

In a fabricating method, a patterning process including a photolithography operation and an etch operation may be used to form the optical device dies D. In this case, the positions and shape of the optical device dies D are defined through the photolithography operation. In more detail, the area of the substrate W may be too large to form all the optical device dies D disposed on the upper portion of the substrate W through a single exposure operation. For this reason, the optical device dies D may be formed through a photolithography process including a plurality of exposure operations (or shots) (at this point, each of the exposure operations may be configured to partially transfer a prototype of patterns constituting the optical device dies D to a predetermined region of the substrate W).

Since the optical device dies D are formed using an identical prototype, they may have the aforementioned substantial identity in shape. In addition, since the optical device dies D are formed through the exposure operations different from each other, they may have the aforementioned independence in function. However, according to a modification of the current embodiment, a single shot or exposure operation may be performed to define a plurality of optical device dies. Since the modification of the current embodiment may be easily implemented is within the scope of the present invention by those of ordinary skill in the art, a description thereof will be omitted.

Since the description of the term “optical device die” is made to describe the scope of the present invention in more detail, the present invention is not limited thereto. Other secondary meanings of the term “optical device die” may be understood based on those of a typical “die” used in technical fields such as a semiconductor integrated circuit field.

Referring to FIGS. 1 and 3, in operation S2, one or more reference marks are formed in a predetermined region of the substrate W. According to an embodiment, the reference marks may be side walls (hereinafter, referred to as first and second reference side walls RS1 and RS2) of the substrate W exposed by cutting (i.e., full sawing) a predetermined region of the substrate W. In more detail, the first and second reference side walls RS1 and RS2 may be formed by cutting portions of the substrate W adjacent to the outermost ones of the optical device dies D, and the first and second reference side walls RS1 and RS2 may be perpendicular to each other.

Referring to FIGS. 1 and 4, in operation S3, the lower surface of the substrate W is partially sawn to form first partial sawing regions PSX1 (or first trenches) that cross the substrate W under first regions of the optical device dies D. The first partial sawing regions PSX1 may be parallel to the first reference side wall RS1 as illustrated in FIG. 8, and be respectively formed at the optical device dies D as illustrated in FIGS. 4 and 9.

Moreover, a pitch P of the first partial sawing regions PSX1 may be substantially identical to a pitch P of the optical device dies D. The pitch P of the optical device dies D may be the sum of the width of one optical device die D and the width of a scribe lane SL formed between the neighboring optical device dies D. Accordingly, the relative position between the optical device die D and the first partial sawing region PSX1 under the optical device die D may be substantially identical in all the optical device dies D. The identity in relative position may be embodied by repeating newly forming of the first partial sawing region PSX1 on the standard basis of the first reference side wall RS1 or on the standard basis of the previously formed first partial sawing region PSX1, as illustrated in FIG. 1.

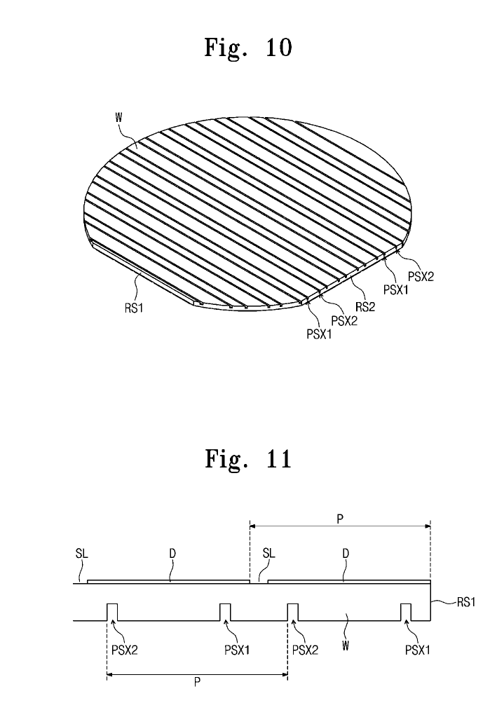

Referring to FIGS. 1 and 5, in operation S4, the lower surface of the substrate W is partially sawn to form second partial sawing regions PSX2 (or second trenches) that cross the substrate W under second regions of the optical device dies D. The second partial sawing regions PSX2 may be parallel to the first reference side wall RS1 and the first partial sawing regions PSX1 as illustrated in FIG. 10, and be respectively formed at the optical device dies D as illustrated in FIGS. 5 and 11.

Moreover, a pitch P of the second partial sawing regions PSX2 may be substantially identical to the pitch P of the optical device dies D. Accordingly, the relative position between the optical device die D and the second partial sawing region PSX2 under the optical device die D may be substantially identical in all the optical device dies D. The identity in relative position may be embodied by repeating newly forming of the second partial sawing region PSX2 using the first reference side wall RS1 or the previously formed second partial sawing region PSX2 as a reference line, as illustrated in FIG. 1.

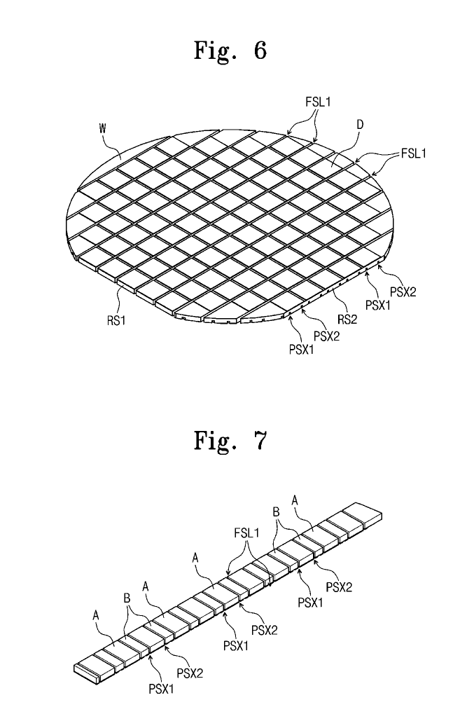

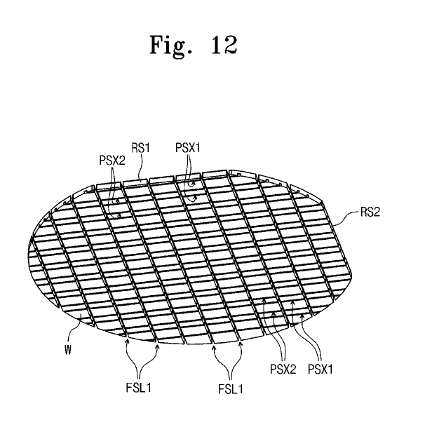

Referring to FIGS. 1 and 6, in operation S5, the lower surface of the substrate W is fully sawn to form full sawing lines FSL1 that cross the first and second partial sawing regions PSX1 and PSX2 and the first reference side wall RS1. The full sawing lines FSL1 may be disposed in the scribe lane regions SL between the optical device dies D, as illustrated in FIGS. 6 and 12.

According to an embodiment, the full sawing lines FSL1 may be formed by repeating the fully sawing of the substrate W using the second reference side wall RS2 as a reference line, as illustrated in FIG. 1. Accordingly, the substrate W may be divided into a plurality of fragment substrates having side walls parallel to the second reference side wall RS2, as illustrated in FIG. 12. Each of the fragment substrates may include the first and second partial sawing regions PSX1 and PSX2 that are disposed along a direction crossing the full sawing lines FSL1.

Referring to FIGS. 1 and 7, in operation S6, a cleaving process is performed to divide each of the fragment substrates into a plurality of fragment dies. The fragment dies may be separated from each other using the first and second partial sawing regions PSX1 and PSX2 as boundaries. In this case, the fragment dies may be classified into first fragments A distant from the scribe lane regions SL, and second fragments B adjacent to the scribe lane regions SL. According to an embodiment, the first fragments A may be used to constitute a photonic device, and the second fragments B may be discarded.

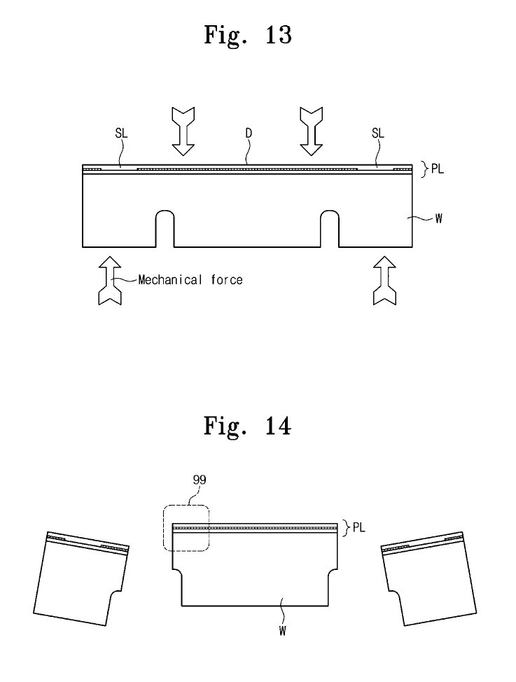

According to an embodiment, the cleaving process in operation S6 may be performed using a mechanical method of applying mechanical force to the first and second partial sawing regions PSX1 and PSX2, as illustrated in FIGS. 13 and 14. In this case, since the first and second partial sawing regions PSX1 and PSX2 form mechanically fragile portions on the substrate W, breaks of the substrate W due to the mechanical force are confined within regions adjacent to the first and second partial sawing regions PSX1 and PSX2, so that breakage of the first fragments A is prevented, and waveguides exposed at side walls of the first fragments A have clear facets.

According to an embodiment of the present invention, the substrate W and the optical device dies D may be formed in a silicon-on-insulator (SOI) wafer. For example, referring to FIG. 16, the SOI wafer may include a lower clad layer LC, a waveguide layer WG, and an upper clad layer UC that are sequentially formed on a single crystal silicon wafer W (Here, FIG. 16 is an enlarged view illustrating the region depicted by dotted lines 99 of FIG. 14). According to embodiments of the present invention, the single crystal silicon wafer W and the waveguide layer WG may be used to constitute the substrate W and the optical device dies D, respectively. However, it is obvious that the present invention is not limited to the using of the SOI wafer.

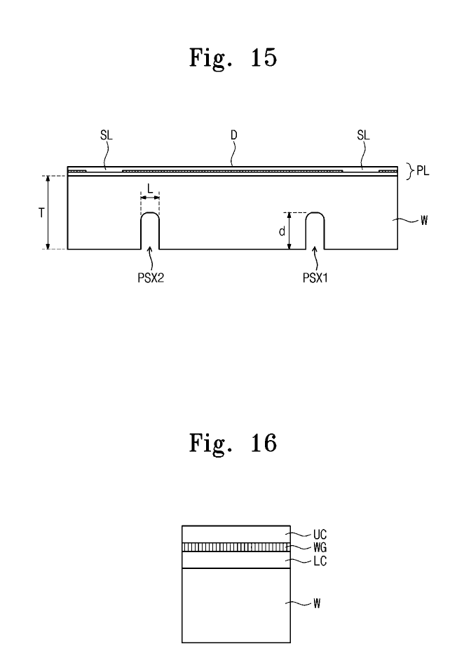

According to embodiments of the present invention, referring to FIG. 15, the first and second partial sawing regions PSX1 and PSX2 have a depth d that may be about half a substrate thickness T. For example, when the substrate W is a single crystal silicon wafer having a thickness of about 689 mm, the depth d of the first and second partial sawing regions PSX1 and PSX2 may range from about 200 mm to about 500 mm. Furthermore, the depth d may range from about 360 mm to about 400 mm. The first and second partial sawing regions PSX1 and PSX2 may have a width L that may rang from about 10 mm to about 1000 mm.

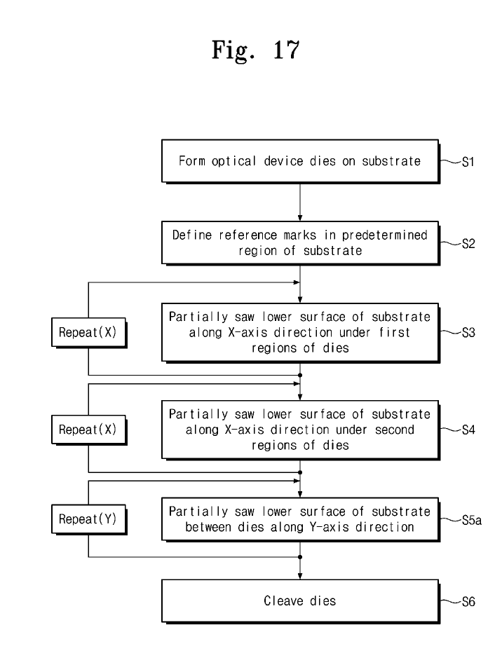

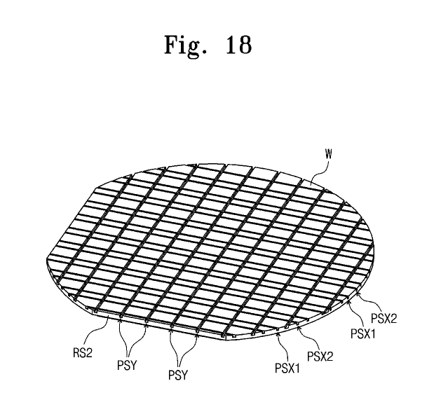

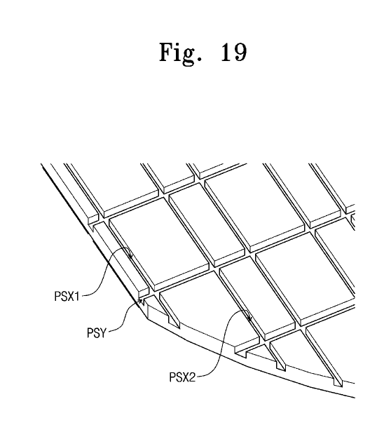

FIG. 17 is a flowchart illustrating a method of forming a waveguide facet according to another embodiment of the present invention. FIGS. 18 and 19 are perspective views illustrating the method of FIG. 17. The same parts of the embodiment of FIGS. 17 through 19 as those of the embodiments described with reference to FIGS. 1 through 16 may be omitted.

Referring to FIGS. 17 through 19, third partial sawing regions PSY are formed by partially sawing the lower surface of the substrate W, instead of the full sawing lines FSL1 dividing the substrate W into the segment substrates. That is, referring to FIGS. 18 and 19, the third partial sawing regions PSY may be formed between the optical device dies D along the direction crossing the first and second partial sawing regions PSX1 and PSX2. The third partial sawing regions PSY may be formed by repeating the partial sawing of the substrate W using the second reference side wall RS2 as a reference line, as illustrated in FIG. 17.

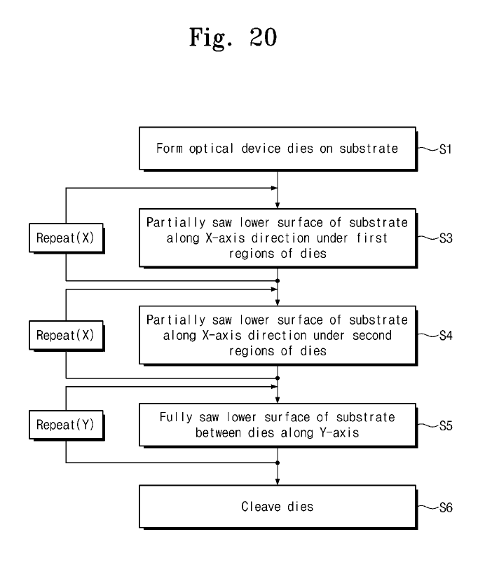

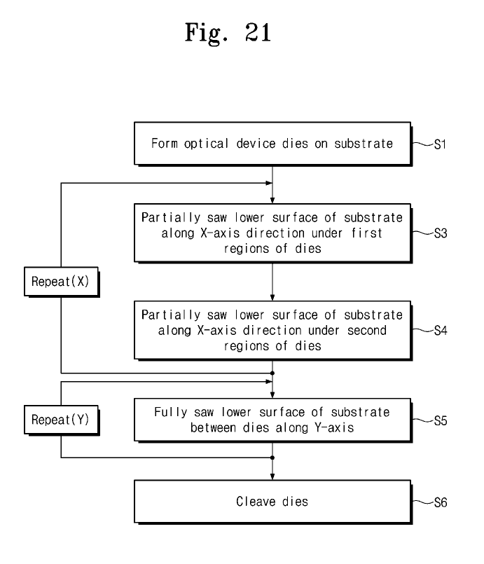

FIGS. 20 and 21 are flowcharts illustrating methods of forming a waveguide facet according to other embodiments of the present invention. The same parts of the embodiments of FIGS. 20 and 21 as those of the embodiments described with reference to FIGS. 1 through 19 may be omitted.

Referring to FIGS. 20 and 21, the operation of forming the reference marks may be removed. In this case, the first and second partial sawing regions PSX1 and PSX2 may be formed using a sawing device including a predetermined sawtooth alignment device. For example, the sawtooth alignment device may be configured to define the relative position between sawteeth disposed at the lower surface of a wafer and a light receiving device (e.g., image sensor) imaging the upper surface of the wafer. When the sawtooth alignment device is used, the first and second partial sawing regions PSX1 and PSX2 can be formed in the state where the upper surface of a wafer is watched in real time.

Referring to FIG. 21, the first and second partial sawing regions PSX1 and PSX2 may be sequentially and repeatedly formed. The embodiment of FIG. 21 is different form the embodiment of FIG. 20 in that the second partial sawing regions PSX2 are formed after all the first partial sawing regions PSX1 are formed in the embodiment of FIG. 20.

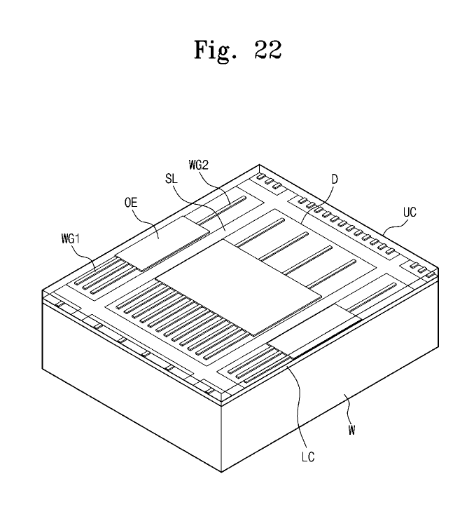

FIGS. 22 through 24 are perspective views illustrating a method of forming a waveguide facet according to an embodiment of the present invention. The same parts of the embodiments of FIGS. 22 through 24 as those of the embodiments described with reference to FIGS. 1 through 21 may be omitted.

Referring to FIG. 22, the dies D defined by the scribe lane regions SL are disposed on the substrate W, and each of the dies D may include one or more input wave guides WG1, one or more output wave guides WG2, and an optical element OE disposed between the input wave guides WG1 and the output wave guides WG2. Since the structure and type of the optical element OE may be varied within the scope of the present invention, a description thereof will be omitted.

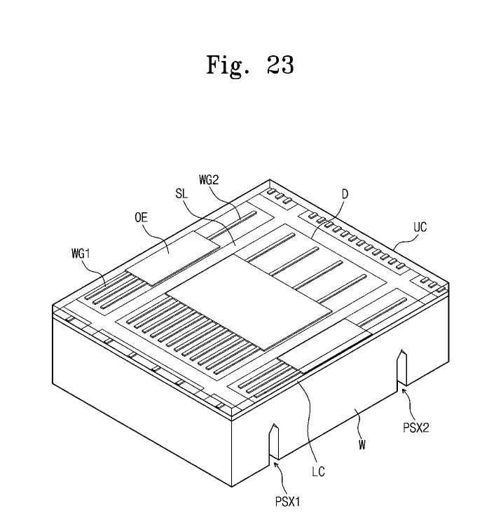

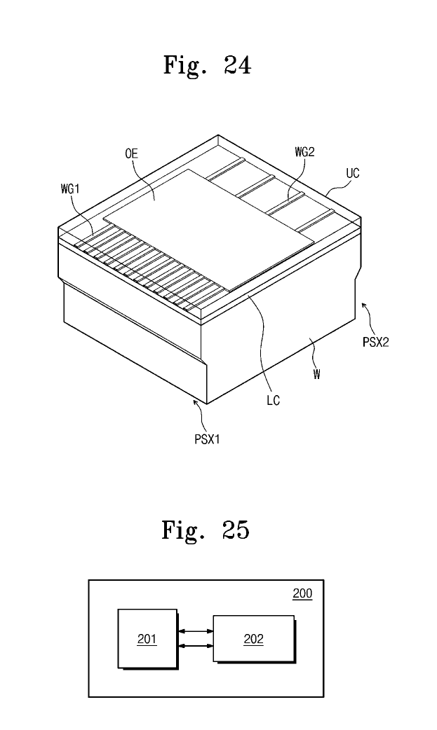

Referring to FIG. 23, the first and second partial sawing regions PSX1 and PSX2, formed using the methods according to the embodiments of FIGS. 1 through 21, may be formed in the lower surface of the substrate W, and the dies D may be cloven using the first and second partial sawing regions PSX1 and PSX2 as boundaries, as illustrated in FIG. 24. As illustrated in FIG. 23, the first and second partial sawing regions PSX1 and PSX2 are spaced apart from the scribe lane regions SL, and formed under the inner portion of the optical device dies D. At this point, since the optical device dies D have boundaries (that is, boundaries of the scribe lane regions SL) defined through the patterning process including the photolithography operation described with reference to FIG. 1, or through a pattern transfer process, the inside and outside of the optical device dies D may be separated by the scribe lane regions SL. As such, the method of the current embodiment is different from the methods of separating semiconductor chips along the scribe lane regions SL, in that a portion of the initially defined die is cut.

FIG. 25 is a schematic view illustrating a photonics device according to an embodiment of the present invention.

Referring to FIG. 25, a photonics device 200 may include a plurality of optical devices (e.g., first and second optical devices 201 and 202) that are optically connected to each other. At least one of the first and second optical devices 201 and 202 may be formed using one of the waveguide facet forming methods described with reference to FIGS. 1 through 24.

From the point of view that optical waveguides formed using one of the waveguide facet forming methods described with reference to FIGS. 1 through 24 are used to form the photonics device 200, the waveguide facet forming methods according to the embodiments of the present invention are different from wafer cleaving processes for analyzing defectiveness of a semiconductor device, in which none of results from the wafer cleaving processes are used as products.

According to the embodiments of the present invention, the method of forming a waveguide facet includes the partially sawing the lower surface of a substrate. Due to the partially sawn region, the substrate can be cloven at a desired position (that is, at a portion of the substrate adjacent the partially sawn region). Since a waveguide having the waveguide facet is cloven together with the substrate under the waveguide, the waveguide facet is clear after the cleaving of the substrate. Moreover, since the cloven portion of the substrate is confined within a desired region, the yield reduction due to cleaving failure can be prevented.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a waveguide facet, the method comprising:
forming at least one optical device die on a substrate, the optical device die including waveguides;
forming at least one trench in a lower surface of the substrate; and
cleaving the substrate to form facets of the waveguides over the trench,
wherein the trench is formed along a direction crossing the waveguides under the waveguides.

2. The method of claim 1, wherein the substrate comprises a material having a single crystal structure.

3. The method of claim 2, wherein the trench defines a fragile region having mechanical fragileness in the substrate, and
the cleaving of the substrate uses the mechanical fragileness of the fragile region to confine positions of the facets over the trench.

4. The method of claim 3, wherein the cleaving of the substrate comprises using a mechanical method to apply mechanical force to the fragile region.

5. The method of claim 1, wherein the substrate is a single crystalline silicon wafer.

6. The method of claim 5, wherein the substrate further comprises a lower layer under the waveguides, the lower layer having low refractivity than that of the waveguide.

7. The method of claim 1, wherein the waveguides are formed of silicon.

8. The method of claim 1, wherein the forming of the optical device die comprises processing a silicon-on-insulator (SOI) wafer including a single crystalline silicon wafer, an oxide layer and a silicon layer,
the single crystal silicon wafer is used as the substrate, and
the silicon layer of the processed silicon-on-insulator wafer is used as the waveguides.

9. The method of claim 1, wherein the optical device die comprises a plurality of optical device dies, which are spatially separated from each other by a boundary region and are arrayed in two dimensions on the substrate, and
the trench is laterally spaced apart from the boundary region between the optical device dies and is formed in the lower surface of the substrate.

10. The method of claim 9, wherein the optical device dies are formed using a pattern transfer process including a plurality of exposure operations, and
the boundary region is formed in regions on which different ones of the exposure operations are performed.

11. The method of claim 9, wherein the forming of the trench comprises forming a plurality of trenches in the lower surface of the substrate, and
one or two of the trenches are formed under each of the optical device dies.

12. The method of claim 11, wherein the optical device dies comprise a reference die spaced a predetermined distance from a side wall of the substrate, and
the forming of at least one trench comprises,
forming a reference trench under the reference die; and
repeatedly forming the trenches using the reference trench as a reference line, distances between the repeatedly formed trenches are one of multiplex numbers of a pitch of the optical device die.

13. The method of claim 1, further comprising, before the forming of the trench, forming a reference mark in a predetermined region of the substrate,
wherein the trench is formed using the reference mark as a reference line.

14. The method of claim 13, wherein the reference mark comprises a side wall of the substrate formed by cutting an edge of the substrate along a direction parallel to the trench.

15. A photonics device comprising an optical device including a connection waveguide to connect optically to an external optical device,
wherein the connection waveguide has a facet disposed at an edge of the optical device, and
the facet of the connection waveguide is formed using the method of claim 1.
